(19) United States
(12) Patent Application Publication
(10) Pub. No.: US 2007/0014119 A1
(43) Pub. Date: Jan. 18, 2007

(54) Variable lighting system for optimizing night visibility

(76) Inventor: Karl A. Burkett, Austin, TX (US)

Correspondence Address: LAW OFFICE OF STEVEN B. LEAVITT, L.L.P., P.O. BOX 537, ROWLETT, TX, 75030-0537, US

(21) Appl. No.: 11/179,956

(22) Filed: Jul. 12, 2005

(51) Int. Cl. B60Q 1/00; B60Q 3/00

(52) U.S. Cl. 362/459

(57) ABSTRACT

A variable lighting system (“VLS”) for optimizing object visibility at night by setting a base level of lighting, adding a variable light to that base level of lighting, and a synchronizing the timing and sequence of the base level of lighting and the variable lighting. The variable lighting system varies light by intensity, color, direction, or a combination thereof. The variable lighting system also optionally includes a detector for detecting motion, noise, and other occurrences. The variable lighting system can be implemented as a fixed lighting source, a movable lighting source, or a vehicle mounted lighting source. The VLS improves visibility at night for viewers or motorists thereby reducing accidents and damage costs. The VLS saves energy and improves the environment and enhances quality of life by reducing light pollution and light trespass.

### BACKGROUND OF THE INVENTION

1. Technical Field

This invention generally relates to lighting systems. Particularly, the invention relates to lighting systems for optimizing night visibility.

2. Description of Related Art

Night visibility is a well known concern of many individuals and is particularly a safety concern for night driving. As a result, artificial lighting such as street lights have been placed on roadways and in parking lots to improve night visibility for motorists. However, artificial lighting is not always sufficient for motorists and individuals so alternatives for improving night visibility have been established.

For example, one method for designing fixed roadway lighting promulgated by the American Standards Institute (ANSI) and Illuminating Engineering Society of North America (IESNA) is termed “Small Target Visibility” and is a method for maximizing the visibility of small (7 inch square) targets on a roadway. However, with this method all objects are still not detectable because there is not enough contrast between the object and background.

There is a desire to optimize headlamp and fixed roadway lighting system interactions to improve visibility. Other systems include aesthetic “under vehicle” lighting as well as variably aimed headlamps wherein both provide some assistance in detecting roadway hazards. These existing lighting systems, while beneficial, use large amounts of power and hence are costly. There is a need for a lighting system that further improves visibility at night on roadways and other artificially lit areas while also being cost effective.

### SUMMARY OF THE INVENTION

The invention described below is a variable lighting system (“VLS”) for optimizing object visibility at night. The VLS comprises a base lighting element, a variable lighting element, and a master synchronizer for synchronizing the timing and sequence of the base level lighting and the variable lighting. The VLS sets the base level of lighting, adds the variable light to the base level of lighting, and synchronizes the timing and sequence of the lighting elements. The VLS varies light intensity, color, and direction and optionally includes a detector for detecting motion, noise, or other occurrences.

The VLS can be implemented as a fixed lighting source, a movable lighting source, or a vehicle mounted lighting source. It improves visibility at night for all viewers, particularly bicycle riders, pedestrians, and motorists thereby reducing accidents and damage costs and saving lives. Furthermore when compared to known lighting systems, the VLS saves energy, improves the environment, and enhances quality of life by reducing light pollution and light trespass.

### BRIEF DESCRIPTION OF DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view illustrating the variable lighting system of the present invention;

FIG. 2 is a flow chart depicting the steps involved in synchronizing the clock of the present invention; and

FIG. 3 is a flow chart depicting the steps involved in synchronizing the timing sequence of the present invention.

### DETAILED DESCRIPTION

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

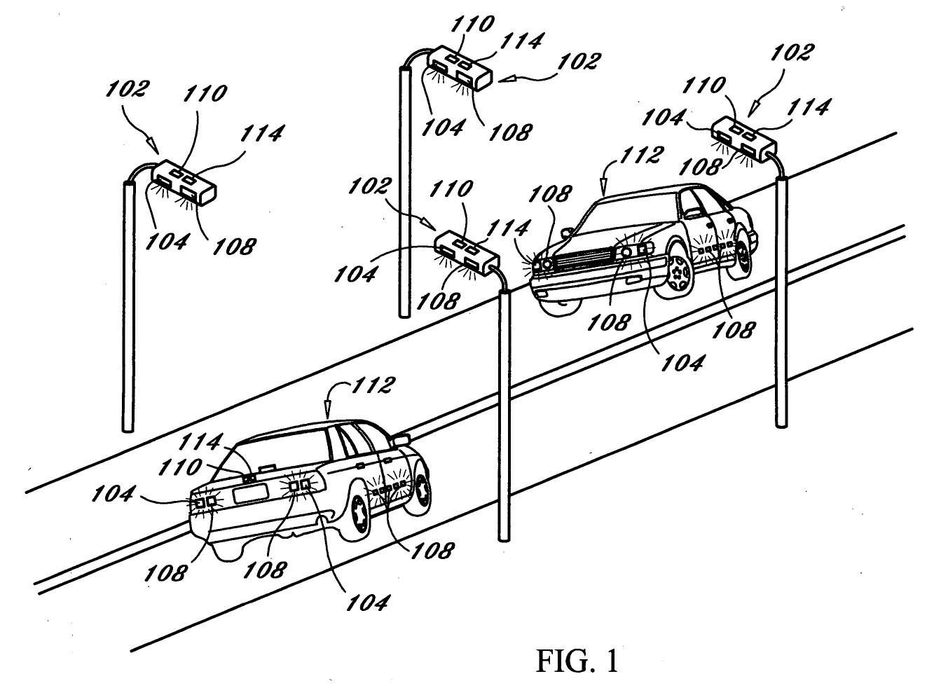

FIG. 1 depicts a variable lighting system (“VLS”) of the present invention. VLS 102 includes base lighting element 104, variable lighting element 108, and may contain synchronizer 110. The illumination range of base element 104 can range from zero to 100 million candle power and may be variable. Preferably the minimum illumination level is the lowest illumination detectable by the human eye based on the surrounding environment and the maximum illumination level is the maximum amount of illumination that would be safe for the surrounding environment. Base lighting element 104 can be configured to consist of light energy in one, a portion of, or all of the visible wavelengths (anything from mono-chromatic to white light). In addition to the illumination from base lighting element 104, if any, variable lighting element 108 adds varying amounts of illumination, color, and/or light direction.

The illumination from variable lighting element 108 can be varied in any given direction. The direction of illumination may be in one direction, such as north, two directions such as north-south, or more such as north-east-south-west directions. For example, to vary the direction of illumination when using one light source and two directions, the variability is provided by an increase in the light intensity emitted by a source in the northward direction, then a decrease in the intensity emitted northward with an increase in the intensity emitted in the southward direction, then a decrease in the intensity emitted southward which is followed by a repeat of the cycle again piecewise-continuously. The cycle frequency itself may be at a steady interval, such as every 0.5 seconds, or variable and can be any frequency greater than about 1/250th of a second, or the smallest amount of flicker the eye can detect. Preferably, the cycle frequency is about 0.5 seconds.

To vary the illumination from one illumination source in more than two directions, for example, north-east-south-west, the light intensity emitted by the source in the northward direction is increased; then the intensity in the northward direction is decreased and the intensity in the eastward direction is increased; then the intensity in the eastward direction is decreased and the intensity in the southward direction is increased; then the intensity in the southward direction is decreased and the intensity in the westward direction is increased; then the intensity in the westward direction is decreased and the intensity emitted northward is increased; and the cycle is then repeated piecewise-continuously. The cycle does not need to be continuously clockwise or counterclockwise and may be in any order or sequence and may be variable. The length of the “on,” “off,” “increase,” or “decrease” cycle of any direction need not be the same as other directions “on,” “off,” “increase,” or “decrease” cycle times and may also be variable in any and all directions. The cycle frequency itself may be at a steady interval, such as every 0.5 seconds, or variable and can be any frequency greater than about 1/250th second, or the amount of flicker the eye can detect. Preferably, the cycle frequency is about 0.5 seconds.

Variable lighting element 108 can also provide illumination using a variable color in a given direction. The light emitted in a given direction may be any color or a combination of colors. For example, red light may be emitted northward, then dimmed and then green light increasingly emitted northward as the red light is dimmed and then the red light increasingly emitted northward as the green light is dimmed. Also, similar light patterns may be emitted southward either at the same time or at a subsequent time period synchronized with the light that is being emitted in another direction. For example, red light may be emitted northward while green light is emitted southward. Then the northward red light is dimmed and green light is increasingly emitted northward while the green southward light is dimmed and the red light is increasingly emitted southward. The variable lighting system in this example will provide a varying color and intensity contrast of red and green. This will provide better contrast compared to the existing method of a simple static intensity contrast, thereby increasing visibility. The color emitted north and south is typically not the same color at the same time.

A similar cycle may occur if more than two directions and/or more than two colors are used. For example, a red light may be emitted northward, a blue light eastward, a green light southward, and a yellow light westward. Then the red light is dimmed and the blue light is increasingly emitted northward while the blue eastward light is dimmed, the green light is increasingly emitted eastward while the green southward light is dimmed, the yellow light is increasingly emitted southward while the yellow westward light is dimmed, and the red light is increasingly emitted westward. The general cycle is repeated piecewise-continuously. The cycle does not need to be continuously clockwise or counterclockwise and may be in any order or sequence and may be variable. The length of the “on,” “off,” “increase,” or “decrease” cycle of any direction need not be the same as other directions “on,” “off,” “increase,” or “decrease” cycle times and may also be variable. The cycle frequency itself may be at a steady interval, such as every 0.5 seconds, or variable and can be any frequency greater than approximately 1/250th second, or the amount of flicker the eye can detect. Preferably, the cycle frequency is about 0.5 seconds. Two, four, six, or eight directions is optimal.

If more than one VLS 102 is used, then each VLS 102 also comprises synchronizer 110. Synchronizer 110 coordinates the timing and sequence of all VLS 102 light emitting components such as base lighting element 104 and variable lighting element 108. Synchronizer 110 provides a timing coordination signal so that directional variability for each color and intensity from each element may work together in harmony so that each lighting element of base lighting element 104 and variable lighting element 108 will increase intensity in the same color and/or direction at the same time and each subsequent action will occur simultaneously from each VLS 102.

Synchronizer 110 may generate timing signals to coordinate the timing and sequence of the lighting intensity, color, and direction of illumination from base lighting element 104 and variable lighting element 108. Each synchronizer 110 contains a clock that is synchronized with a standard timing device or another synchronizer 110 in the area. The standard timing device may be any standard timing device known in the art or may be the AC sine wave located on every power line and generated from the electrical plant supplying electricity to the area. The sequence of the lighting intensity, color, and direction of illumination from base lighting element 104 and variable lighting element 108 is preprogrammed in each VLS 102 and VLS 103 and may be hardwired or rewritable.

The sine wave may also be used to synchronize the timing or clocks of other elements besides the lighting. However, in the preferred embodiment, the synchronizer is used to synchronize the lighting. To synchronize the clocks, the frequency of the sine wave is measured used to create a standard of time. Any other device that can access the sine wave can use the sine wave to create the same standard of time.

Synchronizer 110 emits a wireless synchronization signal to objects such as vehicles or other components not connected to the standard timing device so that any VLS 102 that cannot access the standard timing device can be synchronized with any other VLS 102 in the vicinity. In addition, synchronizer 110 emits a timing signal that includes the sequence of the lighting intensity, color, and direction of illumination from base lighting element 104 and variable lighting element 108. Also, all synchronizers 110 are equipped with priority codes so that one synchronizer acts as a master synchronizer for a given area and the wireless synchronization signal and timing signal are used by all the VLS 102 in the area.

VLS 102 may be implemented as fixed lighting sources or a mobile lighting source. Fixed lighting sources include lights on street light poles, in parking lots or on buildings. Mobile VLS 103 includes any VLS mounted on mobile source such as vehicle 112. Vehicle 112 mounted VLS 103 includes at least one base lighting element 104 and at least one variable lighting element 108. One base lighting element 104 and/or one variable lighting element 108 may be mounted on the front of vehicle 112 similar to headlamps. The at least one base lighting element 104 and at least one variable lighting element 108 may be mounted on the side and/or rear of vehicle 112. A mobile VLS 103 is the same as a fixed VLS 102 except the mobile VLS 103 is on a mobile source and there may be more than one base lighting element 104 and more than one variable lighting element 108.

The intensity of a side or rear mounted base lighting element 104 and variable lighting element 108 may be almost any intensity that is safe for the environment it is being used in. Compared to headlamps which illuminate only in the front, but not necessarily toward the roadway, the illumination from the side or rear mounted base lighting element 104 and variable lighting element 108 may be emitted toward the roadway or any other direction away from the vehicle and may be variable. For example, as the speed increases, the illumination may be directed further away from the vehicle and as the vehicle decelerates the illumination may be directed closer to the vehicle towards the roadway. Base lighting element 104 and variable lighting element 108 may also be at least partially directed towards vehicle 112 to illuminate vehicle 112. The side and rear mounted base lighting element 104 and variable lighting element 108 provide visibility of objects for others outside the vehicle such as other motorists, pedestrians, cyclists, cameras, or other vehicle detectors and to also improve the visibility and identity of the vehicle itself.

In mobile VLS 103, synchronizer 110 synchronizes the lighting system of the vehicle by using any available standard timing device or the wireless synchronization signal emitted from synchronizer 110 of VLS 102. The standard timing device is static and typically will, have priority over the wireless synchronization signal. Exceptions to the priority may include emergency vehicles or other special events.

In the case of an emergency vehicle or other special event, the emergency vehicle or some other source will send a priority signal that will override the lighting pattern of VLS 102 and VLS 103. For example, if a police car or fire engine is speeding to an accident or fire, then all static VLS 102 within a two-block radius may flash a red light. Also, all mobile VLS 103 in the direction of the speeding car or fire engine may flash their lights. This would alert all drivers pedestrians that a police or fire engine is in their area and the drivers and pedestrians could take the appropriate action.

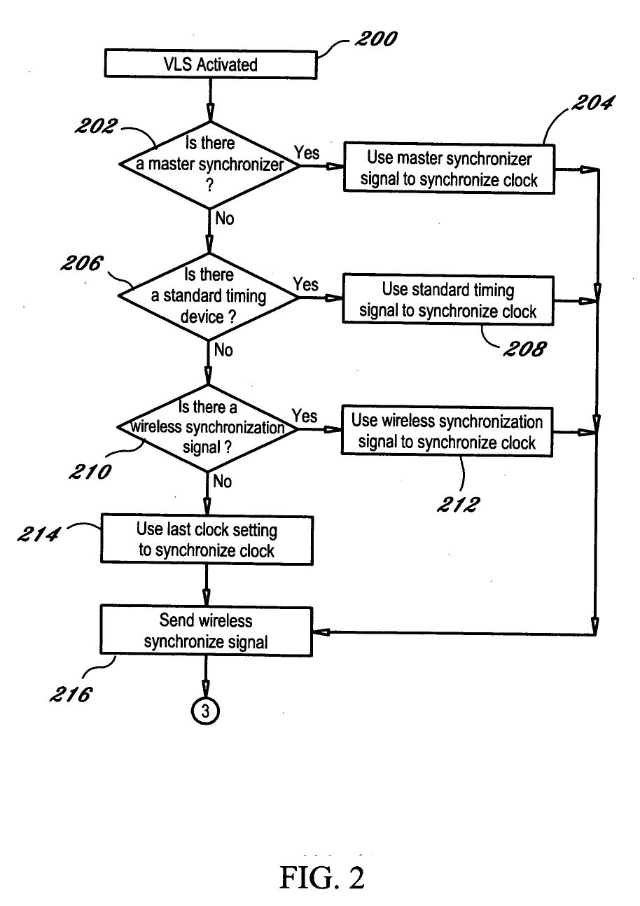

FIG. 2 depicts a method of using the VLS 102 and VLS 103. When the VLS 102 or VLS 103 is first activated, Step 200, the synchronizer 110 checks to determine if there is a master synchronizer 110 to synchronizes the clock in the synchronizer 110, Step 202. If there is a master synchronizer 110, the synchronizer 110 uses the master synchronizer 110 to synchronize its clock, Step 204. If there is not a master synchronizer 110, the synchronizer 110 checks to determine if there is a standard timing device to synchronizes the clocks in the synchronizer 110, Step 206. If there is a standard timing device, such as the AC sine wave described above, the synchronizer 110 uses the master or standard timing device to synchronize its clock, Step 208. If there is not a standard timing device, then the synchronizer 110 determines if there is a lower priority synchronization signal such as a wireless synchronization signal from a synchronizer 110 that is not a master synchronizer 110, Step 210. If there is a lower priority synchronization signal, the synchronizer 110 uses that synchronization signal to synchronize its clock, Step 212. Steps 202 through 212 allow all the clocks of any VLS 102 and VLS 103 within a given area to be to be synchronized. If there is not a lower priority synchronization signal, then the synchronizer 110 uses the last clock setting available, such as a factory clock setting or the last synchronized clock setting, Step 214. After the clock is synchronized, the synchronizer 110 sends out a wireless synchronization signal, Step 216.

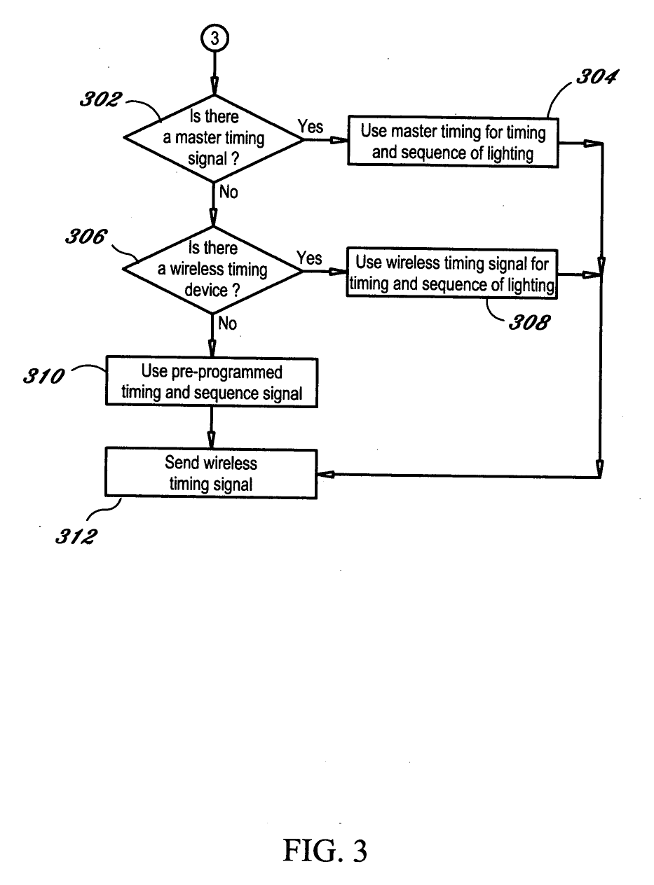

Next, as shown in FIG. 3, the synchronizer 110 checks to determine if there is a master timing signal from a master synchronizer 110 to synchronizes the timing and sequence of the lighting intensity, color, and direction of illumination from base lighting element 104 and variable lighting element 108, Step 302. If there is a master timing signal, the synchronizer 110 uses the master timing signal to synchronize the timing and sequence of the lighting intensity, color, and direction of illumination from base lighting element 104 and variable lighting element 108, Step 304. If there is not a master timing signal, the synchronizer 110 checks to determine if there is a lower priority timing signal such as a wireless timing signal from a synchronizer 110 that is not a master synchronizer 110, Step 306. If there is a lower priority timing signal, synchronizer 110 uses that timing signal to synchronize the timing and sequence of the lighting intensity, color, and direction of illumination from base lighting element 104 and variable lighting element 108, Step 308. Steps 302 through 308 allow all the timing and sequence of the lighting intensity, color, and direction of illumination from base lighting element 104 and variable lighting element 108 for each VLS 102 and VLS 103 within a given area to be to be synchronized. If there is not a lower priority timing signal, then the synchronizer 110 uses the preprogrammed timing signal for the timing and sequence of the lighting intensity, color, and direction of illumination from base lighting element 104 and variable lighting element 108. After the timing sequence is established, the synchronizer 110 sends out a wireless timing signal, Step 312.

For example, vehicles driving in the north direction may receive a timing signal to emit blue lights at a frequency of 0.5 seconds northward and vehicles traveling in the south direction may receive a timing signal to emit green light at a frequency of 0.5 seconds southward. The lighting difference provides the increased contrast necessary to see more objects in the roadway.

A vehicle mounted VLS 103 may be programmed such that if no other vehicle is within a predetermined range, such as approximately 1000 to 1500 feet, then no side and rear vehicle lighting is emitted. The range may be established by the detection of a wireless signal from a VLS 103.

The synchronizer 110 can optionally be configured to include a detector component 114 to detect a predetermined signal such as one from an emergency vehicle, motion detector, noise detector, distress signal, traffic signal, or other unrelated occurrence. If the detector is activated, the VLS 110 may noticeably modify the light emission to produce a flash, flash red, or other color, or produce some other noticeable change. The VLS 102 or VLS 103 response to a predetermined signal may vary with the source of signal. For example, the VLS 102 or VLS 103 may produce a red tint appearance when a traffic signal ahead is red, red flash overtones when an emergency vehicle is nearby, or flash yellow overtone when a lane is closed or other trouble is ahead. Also, fixed lighting may be turned off or dimmed when no vehicles are present or are not in close enough proximity to be of sufficient value to warrant the illumination. This could save on the overall cost of operating a fixed lighting system.

Preferred forms of the invention have been shown in the drawings and described above, but variations in the preferred forms will be apparent to those skilled in the art. For example, the VLS 102 may be used inside a building. The preceding description is for illustration purposes only, and the invention should not be construed as limited to the specific form shown and described. The scope of the invention should be limited only by the language of the following claims.

What is claimed is:

1. A variable lighting system for optimizing night visibility comprising:
at least one variable lighting element having at least one variable illumination source wherein the at least one variable illumination source can be activated and deactivated; and
a synchronizer for synchronizing the timing and sequence of activation and deactivation of the at least one variable lighting element.

2. The variable lighting system of claim 1 further comprising at least one base lighting element and a synchronizer for activating and deactivating the at least one base lighting element.

3. The variable lighting system of claim 1 wherein the at least one variable lighting element can illuminate in at least two directions and can vary the illumination direction by adding, subtracting, increasing, or decreasing emitted light intensity in at least one direction.

4. The variable lighting system of claim 3 wherein the illumination from the at least one variable lighting element is in the visible color spectrum and the at least one variable lighting element varies illumination color by adding, subtracting, increasing, or decreasing emitted light intensity at a given wavelength or at a combination of several wavelengths.

5. The variable lighting system of claim 4 wherein the at least one variable lighting element varies light direction, color, or a combination thereof by applying a steady cycle frequency or a variable cycle frequency.

6. The variable lighting system of claim 5 wherein the variable cycle frequency is synchronized by a timing device.

7. The variable lighting system of claim 6 wherein the timing device is the AC sine wave form from power lines.

8. The variable lighting system of claim 6 wherein the timing device generates a synchronization signal to be received by a second variable lighting element and the second variable lighting element uses the synchronization signal to synchronize the steady cycle frequency or the variable cycle frequency.

9. The variable lighting system of claim 8 wherein the at least one variable lighting element further comprises a detector that emits a signal to turn on the lighting or otherwise vary the lighting, said detector configured for detecting motion, noise, presence, proximity, or combinations thereof.

10. The variable lighting system of claim 6 wherein the variable lighting system is implemented in a fixed lighting source.

11. The variable lighting system of claim 6 wherein the variable lighting system is implemented in a mobile lighting source.

12. The variable lighting system of claim 1 wherein the mobile lighting source is a vehicle.

13. A method for optimizing object visibility at night, the method comprising the steps of:
activating at least one variable lighting element having at least one variable illumination source wherein the at least one variable illumination source can be activated and deactivated; and
synchronizing the timing and sequence of the activation and deactivation of the at least one variable lighting element.

14. The method of claim 13 further comprising the step of activating at least one base lighting element wherein the base lighting element provides illumination.

15. The method of claim 13 wherein the at least one variable lighting element can illuminate in at least two directions and can vary the illumination direction by-adding, subtracting, increasing, or decreasing emitted light intensity in one or more directions.

16. The method of claim 13 wherein the illumination from the at least one variable lighting element is in the visible color spectrum and the at least one variable lighting element varies illumination color by adding, subtracting, increasing, or decreasing emitted light intensity at a given wavelength or at a combination of several wavelengths.

17. The method of claim 16 wherein the at least one variable lighting element varies light direction, color, or a combination thereof by applying a steady cycle frequency or a variable cycle frequency.

18. The method of claim 17 wherein the variable cycle frequency is synchronized by a timing device.

19. The method of claim 18 wherein the timing device generates a synchronization signal to be received by a second variable lighting element and the second variable lighting element uses the synchronization signal to synchronize the steady cycle frequency or the variable cycle frequency.

20. The method of claim 14 wherein the at least one variable lighting element further comprises a detector that emits a signal to activate the lighting or otherwise vary the lighting, said detector configured for detecting motion, noise, presence, proximity or combinations thereof.
